(19) United States
(12) Patent Application Publication
(10) Pub. No.: US 2008/0090637 A1
(43) Pub. Date: Apr. 17, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/790,457

(22) Filed: Apr. 25, 2007

Related U.S. Application Data
(60) Provisional application No. 60/852,017, filed on Oct. 17, 2006.

(51) Int. Cl. A63F 13/00

(52) U.S. Cl. 463/20

(57) ABSTRACT

The plural symbols are rearranged with different timings. Under state before one symbol is rearranged, when a symbol to be rearranged is at a stage having a possibility that a winning will occur in connection with the symbols having been already rearranged, the voice related to the winning is outputted from a speaker.

### CROSS REFERENCE TO RELATED APPLICATION

This application claims the benefit of U.S. Provisional Application No. 60/852,017, filed on Oct. 17, 2006.

### BACKGROUND OF THE INVENTION

1. Field of the Invention

The invention relates to a slot machine and a playing method thereof.

2. Description of Related Art

In a conventional slot machine, when a player inserts a game medium such as coin or bill into an insertion slot of the slot machine and pushes a spin button, plural symbols are scroll-displayed in a display mounted on a front of a cabinet and the symbols are then stopped automatically.

In such slot machine, as disclosed in U.S. Pat. No. 6,604,999 B2 or U.S. Patent No. 2002065124A1, for example, when the symbols stopped on a payline constitute a predetermined combination, predetermined number of game media are paid out. In addition, when a certain symbol referred to as scatter symbol is displayed on the display, predetermined number of game media are paid out in accordance with the number of scatter symbols displayed, irrespective of the payline. In other words, in the conventional slot machine, the payout is made in combination with the two methods.

The invention provides a slot machine having an entertainment characteristic, which is not provided to the prior art, and a playing method thereof.

### SUMMARY OF THE INVENTION

The invention provides a slot machine having a structure as described below and comprising a display forming a plurality of areas for arranging plural symbols, a speaker for outputting voice and a controller programmed to carry out following operations of (a) to (c). Specifically, the controller is programmed (a) to rearrange the plural symbols in the areas, based on a predetermined timing, (b) to determine a winning through a relation of the symbols rearranged, and (c) to control the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, to output voice related to the winning from the speaker.

The invention provides a slot machine having a structure as described below and comprising a display having a plurality of paylines and forming a plurality of areas for arranging plural symbols so that the areas intersect the paylines, a speaker for outputting voice and a controller programmed to carry out following operations of (a) to (c). Specifically, the controller is programmed (a) to rearrange the plural symbols on the paylines, based on a predetermined timing, (b) to determine a winning through a relation of the symbols rearranged on the paylines, and (c) to control the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, to output voice related to the winning from the speaker.

The invention provides a slot machine having a structure as described below and comprising a display forming a plurality of areas for arranging plural symbols including plural scatter symbols, a speaker for outputting voice and a controller programmed to carry out following operations of (a) to (c). Specifically, the controller is programmed (a) to rearrange the plural symbols, based on a predetermined timing, (b) to determine a winning through a relation of scatter symbols rearranged which are the rearranged symbols, and (c) to control the symbols so that a timing for rearranging the symbols in at least one area is different from a timing for rearranging the symbols in another area, and, under state before the symbols are rearranged in the one area, when a scatter symbol to be rearranged in the one area is at a stage having a possibility that a winning will occur in connection with the scatter symbols having been already rearranged in the areas, to output voice related to the winning from the speaker.

The invention provides a slot machine having a structure as described below and comprising a display having a plurality of paylines and forming a plurality of areas for arranging plural symbols including plural scatter symbols so that the areas intersect the paylines, a speaker for outputting voice and a controller programmed to carry out following operations of (a) to (c). Specifically, the controller is programmed (a) to rearrange the plural symbols on the paylines, based on a predetermined timing, (b) to determine a winning through a relation of the symbols rearranged on the paylines or a relation of scatter symbols rearranged which are the rearranged symbols, and (c) to control the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, to output voice related to the winning from the speaker.

The invention provides a playing method of a slot machine using a display forming a plurality of areas for arranging plural symbols. The playing method of the slot machine comprises steps of (a) rearranging the plural symbols, based on a predetermined timing; (b) determining a winning through a relation of the symbols rearranged; and (c) controlling the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, outputting voice related to the winning from a speaker.

The invention provides a playing method of a slot machine using a display having a plurality of paylines and forming a plurality of areas for arranging plural symbols so that the areas intersect the paylines. The playing method of the slot machine comprises steps of (a) rearranging the plural symbols on the paylines, based on a predetermined timing; (b) determining a winning through a relation of the symbols rearranged on the paylines; and (c) controlling the symbols so that a timing for rearranging the symbols in at least one area is different from a timing for rearranging the symbols in another area; and, under state before the symbols are rearranged in the one area, when a symbol to be rearranged in the one area is at a stage having a possibility that a winning will occur in connection with the symbols having been already rearranged in the areas, outputting voice related to the winning from a speaker.

The invention provides a playing method of a slot machine using a display forming a plurality of areas for arranging plural symbols including plural scatter symbols. The playing method of the slot machine comprises steps of (a) rearranging the plural symbols, based on a predetermined timing; (b) determining a winning through a relation of scatter symbols rearranged which are the rearranged symbols; and (c) controlling the symbols so that a timing for rearranging the symbols in at least one area is different from a timing for rearranging the symbols in another area, and, under state before the symbols are rearranged in the one area, when a scatter symbol to be rearranged in the one area is at a stage having a possibility that a winning will occur in connection with the scatter symbols having been already rearranged in the areas, outputting voice related to the winning from a speaker.

The invention provides a playing method of a slot machine using a display having a plurality of paylines and forming a plurality of areas for arranging plural symbols including plural scatter symbols so that the areas intersect the paylines. The playing method of the slot machine comprises steps of (a) rearranging the plural symbols on the paylines, based on a predetermined timing; (b) determining a winning through a relation of the symbols rearranged on the paylines or a relation of scatter symbols rearranged which are the rearranged symbols; and (c) controlling the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, outputting voice related to the winning from a speaker.

### BRIEF DESCRIPTION OF THE DRAWINGS

FIG. 1 illustrates a playing method of a slot machine;

FIG. 2 is a block diagram of a slot machine;

FIG. 3 illustrates a display screen;

FIG. 4 illustrates a display screen;

FIG. 5 illustrates a display screen;

FIG. 6 shows symbols and code numbers thereof;

FIG. 7 is a perspective view showing an external appearance of a slot machine;

FIG. 8 is a block diagram showing a control circuit of a slot machine;

FIG. 9 shows a voice management table;

FIG. 10 is a flow chart of a game executing process;

FIG. 11 illustrates a playing method of a slot machine; and

FIG. 12 is a block diagram of a slot machine.

### DESCRIPTION OF THE PREFERRED EMBODIMENTS

### Embodiment 1

It will be described an embodiment 1 of a slot machine and a playing method thereof according to the invention.

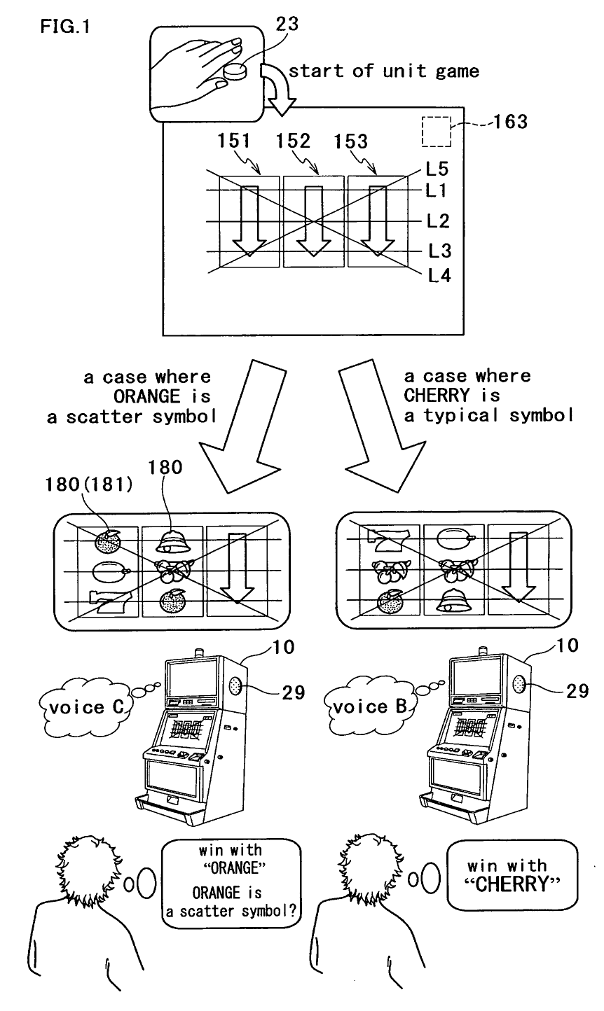

As shown in FIG. 1, a slot machine 10 executes a playing method comprising steps of rearranging plural symbols 180, based on a predetermined timing; determining a winning through a relation of the symbols 180 rearranged on a plurality of paylines L; determining a winning through a relation of scatter symbols 181 rearranged which are the rearranged symbols; controlling the symbols so that a timing for rearranging the symbols in at least one area (one of display windows 151˜153) is different from a timing for rearranging the symbols in another area; and under state before the symbols are rearranged in the one area, when a symbol to be rearranged in the one area is at a stage having a possibility that a winning will occur in connection with the symbols having been already rearranged in the areas, outputting voice related to the winning from a speaker 29.

Herein, the “arrangement” means a state in which the symbols 180 including the scatter symbol 181 are allowed to be visible with naked eyes of an exterior player. In other words, in FIG. 1, the symbols 180 are under state of being displayed in the display windows 151˜153. In the mean time, the “rearrangement” is meant by arranging the symbols 180 again after dismissing the arrangement of the symbols 180. In addition, the “payline” L is provided to determine a combination of the symbols 180. Specifically, three symbols 180 are arranged in each of the display windows 151˜153, so that 9 symbols 180 are arranged. Five paylines L are set for the nine symbols 180. In other words, it is provided a top line L1, a center line L2 and a bottom line L3 in a vertical direction, which horizontally intersect the three symbols 180, and a cross down line L4 and a cross up line L5 intersecting in a diagonal direction. It is determined a combination of the symbols 180 rearranged on the same payline L. As a result of the determination for a combination, when it is made a winning combination, it is carried out, for example, a process of paying out a coin in accordance with the winning combination.

In addition, the “scatter symbol 181” is a symbol making it a condition that a winning is made through only the arrangement thereof, irrespective of the paylines L. In other words, when the scatter symbol 181 is rearranged, a winning is made and it is carried out, for example, a process of paying out a coin in accordance with the number of all the scatter symbols 181 rearranged, irrespective of whether it is rearranged on the same payline L. In addition, when predetermined number of the scatter symbols 181 is rearranged, a winning of the scatter symbol is made and a coin is paid out. Furthermore, the “symbol 180” means all symbols used in the slot machine 10 and includes the scatter symbol 181. The payline L, the symbol 180, the scatter symbol 181 and the winning combination will be more specifically described later.

(Display Unit 101)

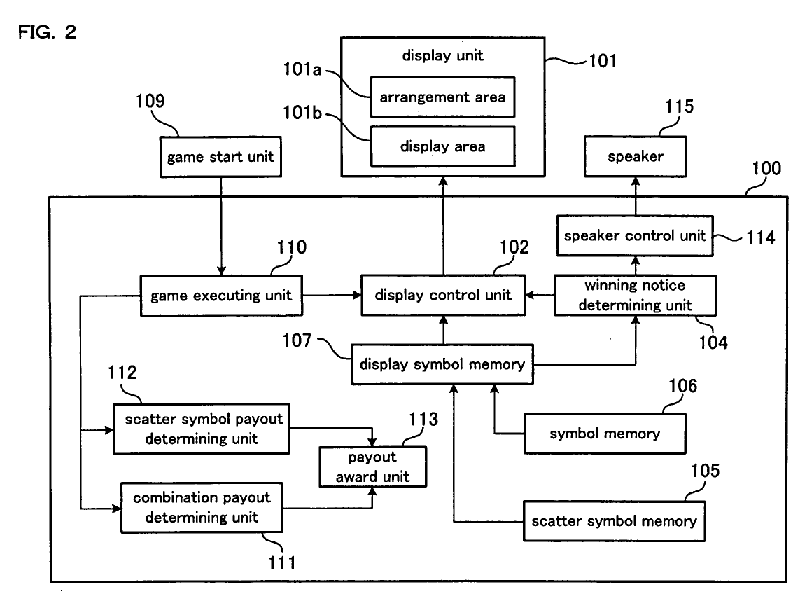

As shown in FIG. 2, the slot machine executing the above playing method is provided with a display unit 101 (display), a speaker 115 and a controller 100. The display unit 101 is structured to have the plural paylines L and to arrange the plural symbols 180 including the scatter symbol 181. In addition, the display unit 101 is adapted to provide a final symbol display unit 163 (display area) to a part different from the display windows 151˜153 (arrangement area) for arranging the symbols 180. The final symbol display unit 163 displays the symbol 180 (hereinafter, this symbol is referred to as a final symbol 182). When the final symbol 182 displayed in the final symbol display unit 163 is rearranged, there is case where a winning combination is made. When a winning combination is made, a winning is made. In addition, in case that the final symbol 182 is a scatter symbol 181, when the final symbol 182 displayed in the final symbol display unit 163 is rearranged, a winning is made which is related to a case where predetermined number of the scatter symbols 181 is rearranged.

The display unit 101 may be a mechanical structure with a reel device for arranging the symbols 180 by rotation of a reel or electrical structure with a video reel on which an image is displayed for arranging the symbols 180. Further, the display unit 101 may be a structure of combining a mechanical structure (reel) and an electrical structure (video reel). The electrical structure may include a liquid crystal device, a CRT (cathode-ray tube), a plasma display and the like. In addition, the number of the display windows 151˜153 (arrangement area) is not particularly limited. A detailed structure of the display unit 101 will be described later.

(Speaker 115)

When the final symbol 182 is determined, the speaker 115 outputs voice related to a winning (a winning having an occurrence possibility) depending on the final symbol 182. As described above, the final symbol 182 is a symbol 180 concerned in a winning establishment.

(Controller 100)

The controller 100 is structured to execute a first process of arranging the symbols 180 in an arrangement area 101a (display windows 151˜153) of the display (display unit 101) and rearranging the symbols 180 based on timings each of which is set to be different in the respective display windows 151˜153, a second process of awarding a payout determined by a combination of the symbols 180 rearranged on the payline L, a third process of when predetermined number of the scatter symbols 181 is rearranged, awarding a payout determined on the basis of the scatter symbol 181, a fourth process of under state before the symbols 180 are rearranged in the part of the arrangement area 101a, determining whether a symbol 180 to be rearranged in the arrangement area 101a has a possibility that a winning will occur in connection with the symbols 180 having been already arranged in the arrangement area 101a, and a fifth process of outputting voice related to a winning having an occurrence possibility from the speaker 115. In other words, the controller 100 comprises first to fifth processing units.

The controller 100 comprises a scatter symbol memory 105 for storing a scatter symbol 181, a symbol memory 106 for storing all symbols including the scatter symbol 181 and a display symbol memory 107 for storing the symbols in the respective memories 105, 106 as a display symbol. The display symbol memory 107 can be accessed by a display control unit 102. The display control unit 102 sets the arrangement area 101a for arranging the plural symbols 180 and the display area 101b for displaying a final symbol in the different parts of the display unit 101. In addition, the display control unit 102 reads out the symbol 180 in the display symbol memory 107 under control of a game executing unit 110 and displays the plural symbols 180 in the arrangements area 101a and the final symbol 182 in the display area 101b. A detailed display state will be described later.

In addition, the controller 100 is connected to a game start unit 109. The game start unit 109 has a function of outputting a game start signal in accordance with control of the player. The controller 100 comprises a game executing unit 110 for rearranging the symbols with an input of a game start signal, as trigger, from the game start unit 109, a combination payout determining unit 111 for determining a payout determined by a combination of the symbols rearranged on the payline in a unit game, a scatter symbol payout determining unit 112 for determining a payout determined on the basis of the scatter symbol rearranged, irrespective of the paylines L and a payout award unit 113 for awarding the respective payouts determined in the combination payout determining unit 111 and the scatter symbol payout determining unit 112.

Further, the controller 100 has a winning notice determining unit 104. The winning notice determining unit 104 determines whether there is a symbol 180 whose a winning combination is made in connection with the symbols 180 having been already rearranged in the arrangement area 101a (display windows 151˜153) or a symbol 180 whose predetermined number of the scatter symbol is rearranged, in a unit game.

Furthermore, the controller 100 has a speaker control unit 114. When a winning notice determining unit 104 determines that there is a symbol 180 having a possibility that a winning combination will be made or a symbol 180 having a possibility that predetermined number or more of scatter symbols will be rearranged, the speaker control unit 114 outputs the voice related to a winning (a winning having an occurrence possibility) depending on the symbol 180 (final symbol 182) from the speaker 115.

In the mean time, each block of the controller 100 may be structured with a hardware or software, as required.

(Operation of Controller 100)

In the above structure, an operation of the controller 100 is described.

When a game start signal is outputted from the game start unit 109 by an operation of the player, the display symbol memory 107 starts a process and the game executing unit 110 starts a unit game, so that the symbols 180 are rearranged (first process). At this time, the symbols 180 are rearranged in each of the display windows 151˜153 with different timings. When the unit game is executed to rearrange the symbols 180, the winning notice determining unit 104 determines whether there is a symbol 180 having a possibility that a winning will occur in connection with the symbols 180 having been already rearranged (fourth process). Then, when it is determined in the winning notice determining unit 104 that a winning combination is made or predetermined number or more of the scatter symbols is rearranged, the display area 101b (final symbol display unit 163) is provided to a part different from the arrangement area 101a (display windows 151˜153) for arranging the symbols 180 and a symbol 180 (final symbol 182) having a possibility that a winning will occur is displayed in the display area 101b. In addition, the voice related to the winning having the occurrence possibility is outputted from the speaker 115 (fifth process).

Next, when all the symbols 180 are rearranged in the arrangement area 101a (display window 151˜153), a payout is awarded by the combination payout determining unit 111 and the payout award unit 113, which is determined by a combination of the symbols 180 rearranged on the payline L. Thereby, the controller 100 rearranges the symbols, thereby executing the second process of awarding a payout determined by the combination of the symbols 180 rearranged on the payline L. In addition, a payout determined by the number of the scatter symbols 181 rearranged is awarded by the scatter symbol payout determining unit 112 and the payout award unit 113. Thereby, the controller 100 rearranges the symbols, thereby executing the third process of awarding the payout determined on the basis of the scatter symbol 181 rearranged.

As can be seen from the above operation, the slot machine 10 embodies the playing method having the steps of rearranging the plural symbols 180, based on the predetermined timing, determining a winning through a relation of the symbols 180 rearranged on the plural paylines L, determining a winning through a relation of the scatter symbols 181 which are the rearranged symbols, controlling the symbols so that a timing for rearranging the symbols in at least one area (one of the display windows 151˜153) is different from a timing for rearranging the symbols in another area, and under state before the symbols are rearranged in the one area, when a symbol to be rearranged in the one area is at a stage having a possibility that a winning will occur in connection with the symbols having been already rearranged in the areas, outputting the voice related to the winning from the speaker 115.

(Display State)

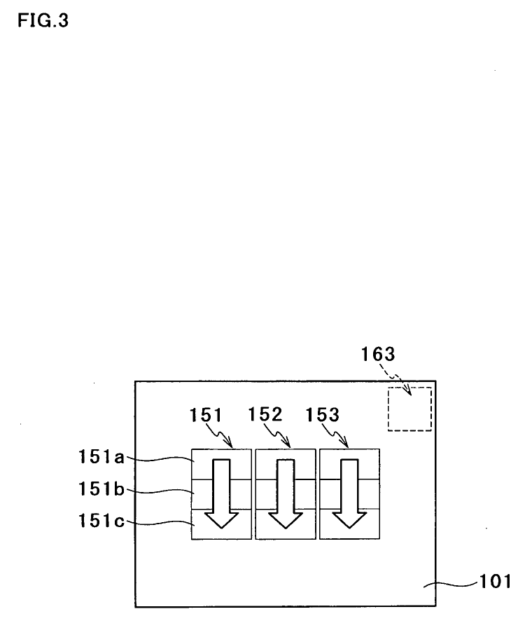

It is specifically described an example of a display state of the display unit 101, with respect to the operation processes of the slot machine 10 and the playing method. In the mean time, as shown in FIGS. 3 to 5, the display state is described with reference to a structure in which the display unit 101 arranges the symbols with a video reel manner.

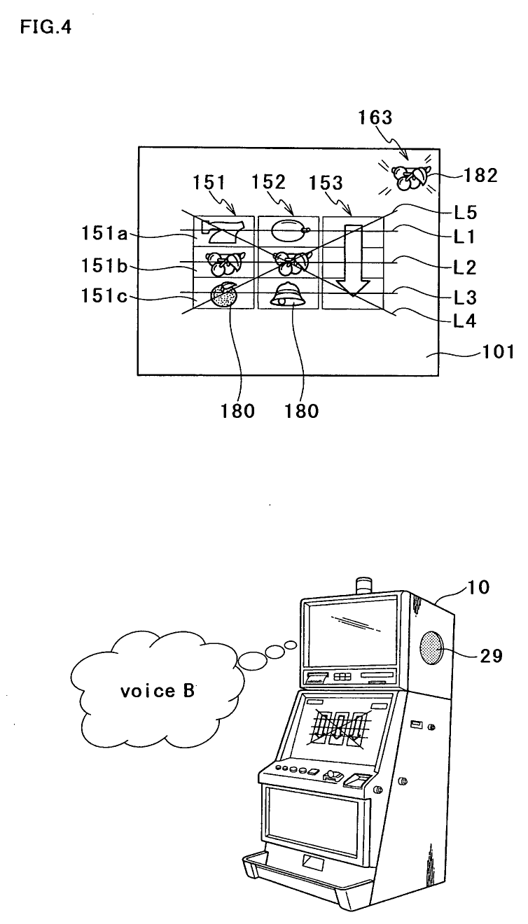

The display unit 101 has display windows 151˜153 as the arrangement area for arranging the plural symbols. The display windows 151˜153 are arranged in a central part of the display unit 101. In the display windows 151˜153, symbol columns consisting of the plural symbols 180 are scroll-displayed. In addition, each of the display windows 151˜153 is divided into upper, center and lower stages 151a, 151b, 151c. Furthermore, in FIG. 3, the paylines L are omitted to easily see the drawing. Each of the symbols 180 is stopped (arranged) in the respective stages 151a, 151b, 151c. For example, in FIG. 4, “BLUE 7” is stopped in the upper stage 151a of the display window 151, “CHERRY” is stopped in the center stage 151b of the display window 151 and “ORANGE” is stopped in the lower stage 151c of the display window 151. As a result, the display windows 151˜153 display a symbol matrix consisting of 3 columns and 3 rows. In the mean time, the symbol matrix is not limited to 3 columns/3 rows.

In addition, the display unit 101 has a final symbol display unit 163 as a display area for displaying a final symbol 182. The final symbol display unit 163 is arranged at a right-handed upper part of the display unit 101 so as not to overlap with the display windows 151˜153. In the mean time, the final symbol display unit 163 may be provided to an arbitrary position on condition that it can avoid the overlapping with the display windows 151˜153. In addition, the display area for displaying the final symbol 182 may be displayed in the display unit 101, i.e., a display different from the lower image display panel 16, for example the upper image display panel 33. Alternatively, a dedicated display may be provided.

In the display unit 101 structured as described above, a display state of FIG. 3 shows a state just after the unit game is started. In other words, the display state of FIG. 3 is made before the symbols 180 are rearranged in the display windows 151˜153. A final symbol 182 is not displayed in the final symbol display unit 163.

A display state of FIG. 4 shows a state then the symbols 180 are rearranged in the display windows 151, 152 and just before the symbols are rearranged in the display window 153. “CHERRY” is stopped in the center stage 151b of the display window 151 and “CHERRY” is stopped in the center stage 151b of the display window 152. In other words, “CHERRY” is stopped side by side on the payline (center line) L2. A final symbol 182 (CHERRY) is displayed in the final symbol display unit 163. At the same time, as shown in FIG. 4, the voice B related to a winning (a winning having an occurrence possibility) depending on the final symbol 182 (CHERRY) is outputted from the speaker 29 provided to the slot machine 10. Thereby, the player can intuitively recognize that “CHERRY” is stopped in the center stage 151b of the display window 153 to make a winning combination, by listening to the voice related to the winning having the occurrence possibility.

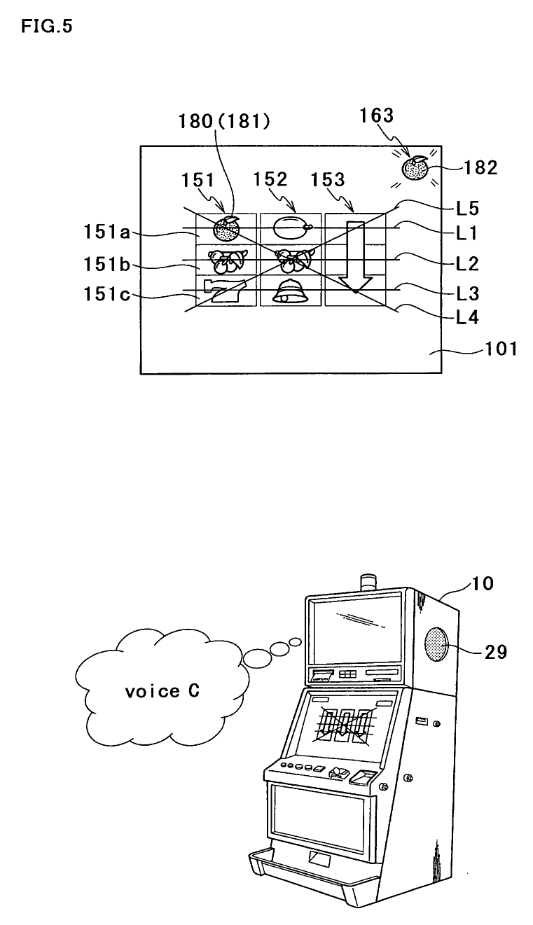

Similarly to FIG. 4, a display state of FIG. 5 shows then the symbols 180 are rearranged in the display windows 151, 152 and just before the symbols 180 are rearranged in the display window 153. Specifically, “ORANGE” is stopped in the upper stage 151a of the display window 151 and “ORANGE” is stopped in the lower stage 151c of the display window 152. A final symbol (ORANGE) 182 is displayed in the final symbol display unit 163. At the same time, as shown in FIG. 5, the voice C related to a winning (a winning having an occurrence possibility) depending on the final symbol 182 (ORANGE) is outputted from the speaker 29 provided to the slot machine 10. Thereby, the player can intuitively recognize that “ORANGE” is stopped in any stage of the display window 153 to make a winning combination, by listening to the voice related to the winning having the occurrence possibility. In addition, since there is a possibility that a winning will be made even though “ORANGE” is not stopped side by side on the same payline, the player can recognize that “ORANGE” has been set as a scatter symbol. Furthermore, the scatter symbol is automatically determined every unit game.

(Symbol, Combination, Etc.)

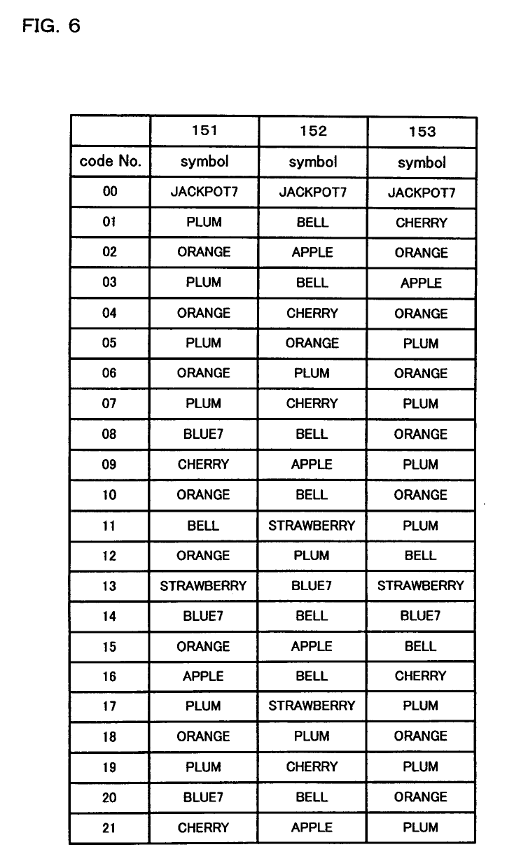

As shown in FIG. 6, the symbols 180 to be displayed in the display windows 151˜153 of the display unit 101 constitute columns of 22 symbols. The symbols constituting the respective columns of symbols are given with one code number of 0˜21. Each of the columns of symbols is constituted with a combination of symbols of “JACKPOT 7,” “BLUE 7,” “BELL,” “CHERRY,” “STRAWBERRY,” “PLUM,” “ORANGE” and “APPLE.”

The three successive symbols in the columns of symbols are displayed (arranged) in the upper, center and lower stages 151a, 151b, 151c of the display windows 151˜153, respectively, so that they constitute a symbol matrix of 3 columns/3 rows in the display windows 151˜153. When a 1-BET button 26 or MAX-BET button 27 is pushed and then a spin button 23 is pushed, the symbols constituting the symbol matrix start the scroll. When the scroll starts, the scrolls of the respective symbols are stopped (rearranged) after a predetermined time period has lapsed.

In addition, various winning combinations are predetermined with regard to the respective symbols. The winning combination is a combination that a combination of symbols stopped on the payline L becomes an advantageous state to the player. The advantageous state is a state in which coins are paid out in accordance with the winning combination, the payout-number of coins is added to a credit, a bonus game is started, and the like.

Specifically, when a combination of “APPLE” symbol is stopped on the payline L, a bonus is triggered and a gaming state is shifted to a bonus game from a basic game. In addition, when a symbol of “CHERRY” is stopped on the payline L, 20 coins (game medium) are paid out per one bet. When a symbol of “PLUM” is stopped on the payline L, 5 coins are paid out per one bet.

In the mean time, a bonus game is a gaming state that is more advantageous than a basic game. In one embodiment, the bonus game is a free game. The free game is a gaming state allowing a player to play a game for a predetermined number of times, without betting a coin. The bonus game is not particularly limited as long as it is a gaming state advantageous to the player, i.e., it is more advantageous than the basic game. For example, the bonus game may include a state in which it is possible to obtain more game medium than the basic game, a state in which it is possible to obtain a game medium in a higher probability than in the basic game, a state in which a game medium is less consumed than in the basic game, and the like. Specifically, a free game, a second game and the like are examples of the bonus game.

(Mechanical Structure)

In the followings, it will be described an example of the slot machine structured in a mechanical and electrical manner.

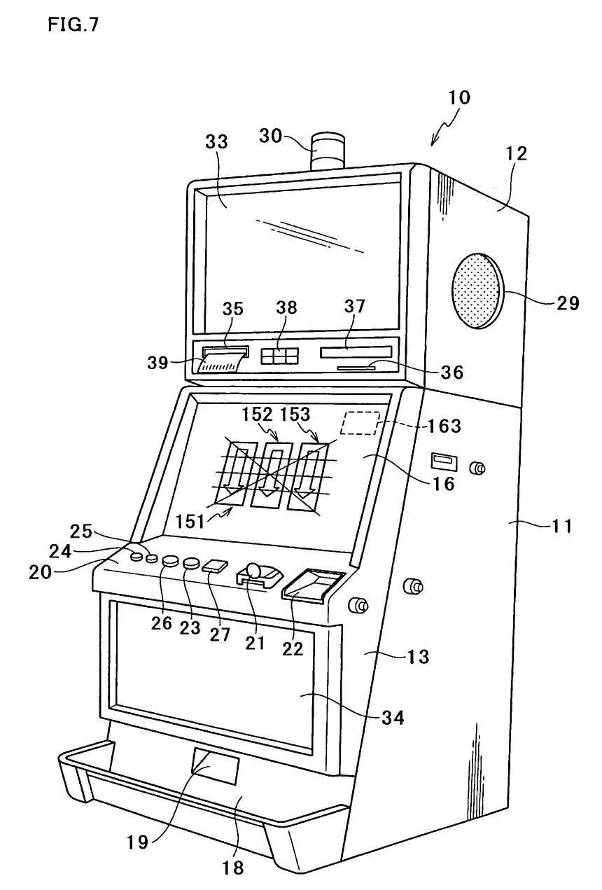

As shown in FIG. 7, the slot machine 10 is provided in a game arcade. The slot machine 10 executes a unit game by using a game medium. The game medium is a coin, bill or electronic negotiable information corresponding to them. Meanwhile, in the invention, the game medium is not particularly limited. For example, a medal, token, electronic money, ticket and the like can be used. The ticket is not particularly limited and may be a ticket with a barcode which will be described later.

The slot machine 10 comprises a cabinet 11, a top box 12 provided to an upper part of the cabinet 11 and a main door 13 provided to a front of the cabinet 11. The main door 13 is provided with a lower image display panel 16. The lower image display panel 16 has a transparent liquid crystal panel for displaying a variety of information. The lower image display panel 16 displays a video reel and a variety of information and effect images relating to a game. Specifically, the lower image display panel 16 displays the display windows 151˜155 of 3 columns/3 rows, the final symbol display unity 163, as shown in FIG. 1, and other effect images, as required.

In the mean time, in this embodiment, it is exemplified a case where the symbols of 3 columns/3 rows are displayed with the lower image display panel 16. However, the invention is not limited thereto. For example, a mechanical reel having symbols provided to a periphery thereof may be rotated and stopped to display symbols which are beyond a display window 15.

The five activated paylines L are displayed in the lower image display panel 16. In addition, the number of the payline L may be one, two or more. Furthermore, when two or more paylines L are provided, the number of paylines L relating to a predetermined condition such as bet-number of coins may be activated.

In the mean time, a credit-number display unit and a payout-number display unit may be displayed in the lower image display panel 16. The credit-number display unit displays a total number that the slot machine 10 can pay out to a player (which will be referred to as total credit-number). The payout-number display unit displays number of coins to be paid out when a combination of symbols stopped on the payline is a winning combination.

A control panel 20, a coin receiving slot 21 and a bill validator 22 are provided below the lower image display panel 16. The control panel 20 is provided with plural buttons 23˜27. The buttons 23˜27 allows instructions, which are related to a game progress by a player, to be inputted. The coin receiving slot 21 enables a coin to be received in the cabinet 11.

The control panel 20 is provided with a spin button 23, a change button 24, a cash out button 25, a 1-BET button 26 and a MAX-BET 27. The spin button 23 is a button for inputting an instruction to start the scroll of symbols. The change button 24 is a button to be used when a player asks a staff in the game arcade for exchange of money. The cash out button 25 is a button for inputting an instruction to pay out the coins of total credit-number into a coin tray 18.

The 1-BET button 26 is a button for inputting an instruction to bet one coin, among coins of the total credit-number, per one game. The MAX-BET button 27 is a button for inputting an instruction to bet maximum coins (for example, 50 coins), among coins of the total credit-number, per one game.

The bill validator 22 validates whether bill is normal or not and receives the normal bill into the cabinet 11. In the mean time, the bill validator 22 can read a ticket 39 having a barcode which will be described later. When the bill validator 22 reads the ticket 39 having a barcode, it outputs a reading signal relating to the read content to a main CPU 41.

A belly glass 34 is provided to a lower frontal surface of the main door 13, i.e., below the control panel 20. A character of the slot machine 10 and the like are drawn on the belly glass 34. An upper image display panel 33 is mounted to a front of the top box 12. The upper image display panel 33 has a liquid crystal panel and displays, for example, an effect image and an image indicating an introduction of a game content and an explanation of a game rule.

To the top box 12 is mounted a speaker 29 for outputting voice. A ticket printer 35, a card reader 36, a data displayer 37 and a keypad 38 are provided below the upper image display panel 33. The ticket printer 35 prints a barcode having data encoded thereto, such as credit-number, date and time, identification number of the slot machine 10 and the like, onto a ticket, thereby outputting the ticket 39 having the barcode. The player can play a game in another slot machine with the ticket 39 having a barcode and exchange the ticket 39 having a barcode with bill in a change booth of the game arcade.

The card reader 36 reads and writes the data from and into a smart card. The smart card is a card carried by a player, into which data for identifying the player and data relating to a game history of the player are memorized.

The data displayer 37 consists of a fluorescent display and the like, and displays the data read by the card reader 36 and the data inputted by the player through the keypad 38. The keypad 38 inputs instructions or data relating to a ticket issue.

(Electrical Structure)

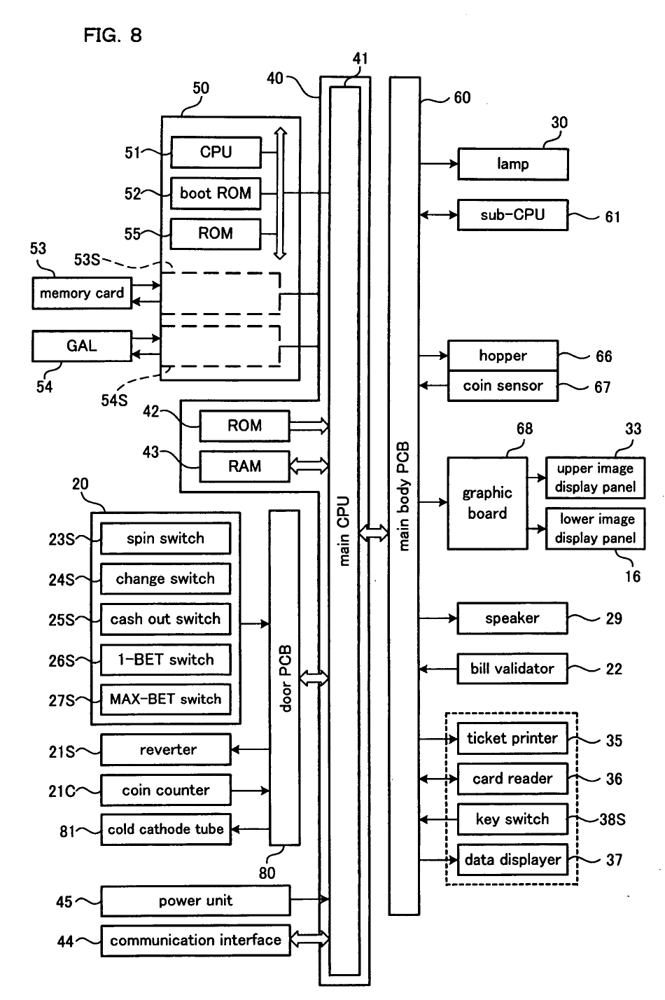

A control unit having the controller 100 shown in FIG. 2 is mounted in the cabinet 11. As shown in FIG. 8, the control unit comprises a motherboard 40, a main body PCB (Printed Circuit Board) 60, a gaming board 50, a sub CPU 61, a door PCB 80, and various switches and sensors.

The gaming board 50 is provided with a CPU (Central Processing Unit) 51, a ROM 55 and a boot ROM 52 which are connected to each other by an internal bus, a card slot 53S corresponding to a memory card 53 and an IC socket 54S corresponding to a GAL (Generic Array Logic) 54.

The memory card 53 stores a game program and a game system program therein. The game program includes a stop symbol determining program. The stop symbol determining program is a program for determining a symbol (code number corresponding to the symbol) to be stopped on the payline L. The stop symbol determining program includes symbol weight data corresponding to each of plural payout rate (for example, 80%, 84%, 88%). The symbol weight data is data representing a correspondence relation between the code number of each symbol and 1 or plural random numbers belonging to a predetermined numerical range (0˜256) for each of the display windows 151˜153.

The payout rate is determined on the basis of data for setting a payout rate, which data is outputted from the GAL 54, and a stop symbol is determined on the basis of the symbol weight data corresponding to the payout rate.

Further, the memory card 53 stores various data used for the game program and the game system program. For example, the data representing a relationship between the symbols 180 displayed in the display windows 151˜153 in FIG. 1 and a range of the random numbers are stored in a table form. In the mean time, these data are transmitted to a RAM 43 of the motherboard 40 when executing the game program.

In addition, the card slot 53S is structured to insert and remove the memory card 53 and connected to the motherboard 40 through an IDE bus. Accordingly, it is possible to change a type or content of a game to be executed in the slot machine, by removing the memory card 53 from the card slot 53S, writing another game program and game system program in the memory card 53 and inserting the memory card 53 into the card slot 53S.

The game program includes a program relating to a game progress and a program for shifting a gaming state into a bonus game. In addition, the game program includes image data and music data which are outputted during the game.

The GAL 54 is provided with plural input and output ports. When the data is inputted into the input ports, the GAL 54 outputs data corresponding to the inputted data from the output ports. The data outputted from the output ports is the data for setting a payout rate which has been described above.

The IC socket 54S is structured to attach and detach the GAL 54. The IC socket 54S is connected to the motherboard 40 through a PCI bus. Accordingly, it is possible to change the data for setting a payout rate which is outputted from the GAL 54, by detaching the GAL 54 from the IC socket 54S, rewriting the program stored in the GAL 54 and then attaching the GAL 54 to the IC socket 54S.

The CPU 51, the ROM 55 and the boot ROM 52, which are connected to each other by the internal bus, are connected to the motherboard 40 through the PCI bus. The PCI bus carries out a signal transfer between the motherboard 40 and the gaming board 50 and supplies power to the gaming board 50 from the motherboard 40. The ROM 55 stores nation identification information and an authentication program. The boot ROM 52 stores a preliminary authentication program and a program (boot code) enabling the CPU 51 to execute the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

The motherboard 40 is provided with a main CPU 41 (controller), a ROM (Read Only Memory) 42, a RAM (Random Access Memory) 43 and a communication interface 44.

The main CPU 41 has functions of a controller for controlling the whole slot machine 10. In particular, the main CPU 41 carries out a control for outputting a command signal enabling the sub CPU 61 to scroll the symbols of the lower image display panel 16 when the spin button 23 is pushed after the credit is bet, a control for determining symbols to be stopped after the symbols are scrolled and a control for stopping the determined symbols in the display windows 151˜153.

In other words, the main CPU 41 has functions of an arrangement controller for selecting and determining arrangement symbols with regard to a symbol matrix from the plural types of symbols so as to rearrange them, as a new symbol matrix after scrolling the plural symbols to be displayed in the lower image display panel 16, and executing an arrangement control which will be stopped at the determined symbols from the scroll state.

In addition, the main CPU 41 has functions of the controller 100 for executing a first process of arranging the symbols 180 in the arrangement area 101a (display windows 151˜153) of the display (display unit 101) and rearranging the symbols 180 based on timings each of which is set to be different in the respective display windows 151˜153, a second process of awarding a payout determined by a combination of the symbols 180 rearranged on the payline L, a third process of when predetermined number of the scatter symbols 181 are rearranged, awarding a payout determined on the basis of the scatter symbol 181, a fourth process of under state before the symbols 180 are rearranged in the part of arrangement area 101a, determining whether a symbol 180 to be rearranged in the arrangement area 101a has a possibility that a winning will occur in connection with the symbols 180 having been already arranged in the arrangement area 101a, and a fifth process of outputting voice related to a winning having an occurrence possibility from the speaker 115.

The ROM 42 stores a program such as BIOS (Basis Input/Output System) executed by the main CPU 41, and data that is permanently used. When the BIOS is executed by the main CPU 41, each of peripheral devices is initialized and the game program and the game system program stored in the memory card 53 are read out through the gaming board 50.

The RAM 43 stores the data and program which is used when the CPU 41 carries out a process. For example, in the RAM 43, the scatter symbol memory 105, the symbol memory 106, and the display symbol memory 107 shown in FIG. 2 are respectively provided in a data area form. The data area of the scatter symbol memory 105 stores the scatter symbol 181. The data area of the symbol memory 106 stores the symbols 180 in the data table form shown in FIG. 6. The data area of the display symbol memory 107 stores the symbols 180 and the scatter symbol 181.

The communication interface 44 is provided to communicate with a host computer and the like through a communication line, which are mounted in the game arcade. In addition, the motherboard 40 is connected to the main body PCB (Printed Circuit Board) 60 and the door PCB 80 through a USB (Universal Serial Bus). Further, the motherboard 40 is connected to a power unit 45. When power is supplied to the motherboard 40 from the power unit 45, the main CPU 41 of the motherboard 40 is operated and the power is supplied to the gaming board 50 through the PCI bus, so that the CPU 51 is also operated.

The main body PCB 60 and the door PCB 80 are connected to a device or apparatus for producing an input signal which will be inputted to the main CPU 41, and a device or apparatus which is controlled by the control signal outputted from the main CPU 41. The main CPU 41 executes the game program and the game system program stored in the RAM 43, based on the input signal inputted to the main CPU 41 to carry out an arithmetic process, thereby storing a result thereof in the RAM 43 and transmitting a control signal to each device and apparatus to control it.

The main body PCB 60 is connected with a lamp 30, the sub CPU 61, a hopper 66, a coin sensor 67, a graphic board 68, the speaker 29, the bill validator 22, the ticket printer 35, the card reader 36, a key switch 38S and the data displayer 37.

The lamp 30 is turned on/off on the basis of the control signal outputted from the main CPU 41. The sub CPU 61 controls the scroll of symbols of the display windows 151˜153 and is connected to a VDP (Video Display Processor) 46. The VDP 46 reads out image data of the symbol stored in an image data ROM 47, produces a scroll image to be displayed in the display windows 151˜153 and outputs the scroll image in the lower image display panel 16.

The hopper 66 is mounted in the cabinet 11 and pays out predetermined number of coins to the coin tray 18 from the coin payout slot 19, based on the control signal outputted from the main CPU 41. The coin sensor 67 is mounted in the coin payout slot 19 and outputs an input signal to the main CPU 41 when it detects that the predetermined number of coins are paid out from the coin payout slot 19.

The graphic board 68 controls an image display in the upper image display panel 33 and the lower image display panel 16, based on the control signal outputted from the main CPU 41. In addition, the graphic board 68 is provided with a VDP for producing image data on the basis of the control signal outputted from the main CPU 41, a video RAM for temporarily storing the image data produced by the VDP, and the like.

The bill validator 22 reads an image of the bill and accommodates the normal bill in the cabinet 11. In addition, in accommodating the normal bill, the bill validator 22 outputs an input signal to the main CPU 41, based on an amount of the bill. The main CPU 41 stores a credit-number, which corresponds to the amount of the bill transmitted by the input signal, in the RAM 43.

The ticket printer 35 prints a barcode having data encoded thereto, such as credit-number stored in the RAM 43, date and time, identification number of the slot machine 10 and the like, on a ticket, based on the control signal outputted from the main CPU 41, thereby outputting the ticket 39 having the barcode.

The card reader 36 reads the data from the smart card to transmit it to the main CPU 41, and writes the data into the smart card, based on the control signal outputted from the main CPU 41. The key switch 38S is mounted to the keypad 38, and outputs an input signal to the main CPU 41 when the player manipulates the keypad 38. The data displayer 37 displays the data which is read by the card reader 36 and the data which the player inputs through the keypad 38, based on the control signal outputted from the main CPU 41.

The door PCB 80 is connected with the control panel 20, a reverter 21S, a coin counter 21C and a cold cathode tube 81. The control panel 20 is provided with a spin switch 23S corresponding to the spin button 23, a change switch 24S corresponding to the change button 24, a cash out switch 25S corresponding to the cash out button 25, a 1-BET switch 26S corresponding to the 1-BET button 26 and a MAX-BET switch 27S corresponding to the MAX-BET button 27. Each of the switches 23S˜27S outputs an input signal to the main CPU 41 when each of the corresponding buttons 23˜27 is pushed by a player.

The coin counter 21C is mounted in the coin receiving slot 21 and validates whether a coin, which is inserted in the coin receiving slot 21 by the player, is normal or not. A coin except the normal coin is discharged from the coin payout slot 19. In addition, the coin counter 21C outputs an input signal to the main CPU 41 when it detects a normal coin.

The reverter 21S is operated on the basis of the control signal outputted from the main CPU 41 and distributes a coin, which is recognized as a normal coin by the coin counter 21C, to a cash box (not shown) or hopper 66 mounted in the slot machine 10. In other words, when the hopper 66 is fully filled with the coins, the normal coin is distributed into the cash box by the reverter 21S. In the mean time, when the hopper 66 is not fully filled with the coins, the normal coin is distributed into the hopper 66. The cold cathode tube 81 functions as a backlight mounted to rear sides of the lower image display panel 16 and the upper image display panel 33 and is turned on, based on the control signal outputted from the main CPU 41.

(Voice Management Table)

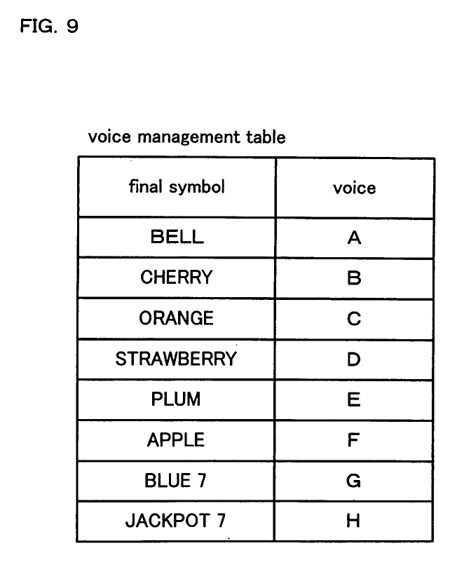

In the followings, it will be described a voice management table for managing the voice related to a winning having an occurrence possibility with reference to FIG. 9. The voice management table is stored in the ROM 42 and is referred to when the voice related to a winning (a winning having an occurrence possibility) depending on a final symbol 182 is outputted from the speaker 29. As shown in FIG. 9, when a final symbol 182 is “BELL,” the voice “A” is outputted from the speaker 29. In addition, when a final symbol 182 is “ORANGE,” the voice “C” is outputted from the speaker 29.

Furthermore, in this embodiment, when the final symbol 182 related to a winning depending on a winning combination is “BELL,” and when the final symbol 182 related to a winning depending on a scatter symbol is “BELL,” the same voice “A” is outputted from the speaker 29. However, the invention is not limited thereto. For example, when the final symbol 182 related to a winning depending on a winning combination is “BELL,” and when the final symbol 182 related to a winning depending on a scatter symbol is “BELL,” the different voices may be outputted from the speaker 29.

(Processing Operation)

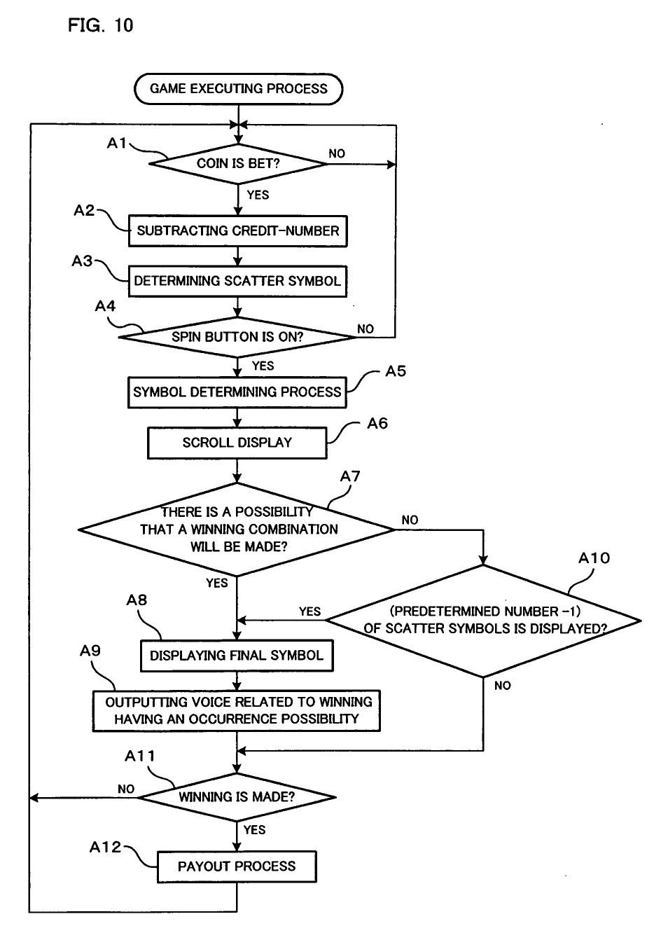

In the followings, it will be described a process which is carried out in the slot machine 10. When the main CPU 41 reads out and executes the game program, a game is started. As shown in FIG. 10, in the game executing process, it is determined whether a coin is bet (A1). In this process, it is determined whether it is received an input signal from the 1-BET switch 26S as the 1-BET button 26 is pushed and whether it is received an input signal from the MAX-BET switch 27S as the MAX-BET button 27 is pushed. When the coin is not bet (A1: NO), the step of A1 is re-executed and it is under standby state until a coin is bet.

In the mean time, when the coin is bet (A1: YES), the credit-number stored in the RAM 43 is subtracted, correspondingly to the number of coins bet (A2). Meanwhile, if the number of coins bet is larger than the credit-number stored in the RAM 43, it is not carried out the process of subtracting the credit-number and the step of A2 is re-executed. In addition, if the number of coins bet is above the upper limit (50 pieces in this embodiment) which can be bet per one game, it is not carried out the process of subtracting the credit-number and a step of A3 is carried out.

Next, a scatter symbol is determined (A3). Specifically, a scatter symbol 181 is automatically selected and stored in the data area of the RAM 43 formed as a scatter symbol memory.

Then, it is determined whether the spin button 23 is ON or not (A4). When the spin button 23 is not ON (A4: NO), the procedure is returned to the step of A1. Meanwhile, in case that the spin button 23 is not ON (for example, the spin button 23 is not ON and an instruction to end the game is inputted), it is canceled the subtraction result in the step of A2.

In the mean time, when the spin button 23 is ON (A4: YES), a symbol determining process is executed (A5). In other words, a stop symbol determining program stored in the RAM 43 is executed, so that it is determined the nine symbols 180 which will be stopped in each stage of the display windows 151˜153. Thereby, it is determined a combination of symbols to be stopped on the payline L.

Next, as shown in FIG. 3, the symbols 180 of the display windows 151˜153 are scroll-displayed (A6). In the mean time, the scroll process is such that the symbols 180 are scrolled in an arrow direction and then the symbols 180 determined in the step of A4 are stopped (rearranged) in the display windows 151˜153.

Next, as shown in FIG. 4 or 5, in the state then the scroll of the symbols 180 in the display windows 151, 152 is stopped and before the symbols of the display window 153 are stopped, it is determined whether there is a possibility that a winning combination will be made (A7). Specifically, when the symbols of the display windows 153 are stopped, it is determined whether there is a possibility that a winning combination will be made on the same payline. When there is a possibility that a winning combination will be made (A7: YES), a final symbol 182 is displayed in the final symbol display unit 163 (A8), as shown in FIG. 4. Then, the voice is outputted from the speaker 29, which is related to a winning depending on the final symbol 182, i.e., a winning having an occurrence possibility (A9). For example, “CHERRY” is stopped side by side on the payline (center line) L2 and the voice “B” related to a winning depending on “CHERRY” is outputted from the speaker 29, so that the player can intuitively recognize that a winning combination is made when “CHERRY” is stopped in the center stage 151b of the display window 153. Then, the process proceeds to a step of A11.

In the mean time, when there is no possibility that a winning combination will be made (A7: NO), it is determined whether “predetermined number—1” of the scatter symbols 181, among the symbols 180 rearranged in the display windows 151, 152, is displayed (A10). In other words, it is determined whether “predetermined number—1” of the scatter symbols determined in the step of A3 is stopped (in this embodiment, the predetermined number is “3”). When the “predetermined number—1” of the scatter symbols 181 is displayed (A10: YES), a final symbol 182 is displayed in the final symbol display unit 163 (A8), as shown in FIG. 5. Then, the voice is outputted from the speaker 29, which is related to a winning depending on the final symbol 182, i.e., a winning having an occurrence possibility (A9). For example, “ORANGE” is stopped in the upper stage 151a of the display window 151, “ORANGE” is stopped in the lower stage 151c of the display window 152 and the voice “C” related to a winning depending on “ORANGE” is outputted from the speaker 29, so that the player can intuitively recognize that a winning is made when “ORANGE” is stopped in any stage of the display window 153. In addition, since it is notified a possibility that a winning will be made even though “ORANGE” is not stopped on the same payline L, the player can recognize that “ORANGE” has been set as the scatter symbol 181. Then, the process proceeds to a step of A11. In addition, when the “predetermined number—1” of the scatter symbols is not displayed (A10: NO), the process proceeds to a step of A11.

In the step of A11, it is determined whether a winning is made (A11). When a winning is made (A11: YES), i.e., a winning combination is made and/or a winning is made due to the display of the scatter symbol 181, a payout process is executed (A12). In other words, it is summed a payout-number of the coins resulting from a winning combination and a payout-number of the coins resulting from the display of the scatter symbol 181. Then, in case of depositing the coins to be paid, a predetermined number of credits are added to the credit-number stored in the RAM 43. In the mean time, in case of paying out the coins, a control signal is transmitted to the hopper 66, so that a predetermined number of the coins are paid out. In the mean time, when a winning is not made (A11: NO), it means a losing. As a result, the process returns to the step of A1.

### Embodiment 2

It will be described an embodiment 2 of the slot machine 10 and the playing method thereof, according to the invention. In the mean time, the same members as the embodiment 1 are referred to with the same reference numerals and descriptions thereof are thus omitted.

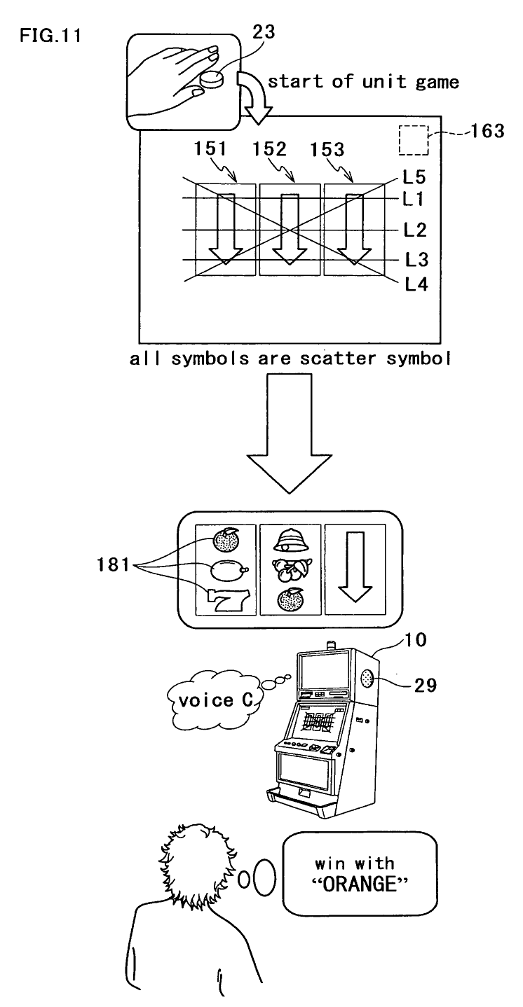

In a slot machine 10 of an embodiment 2, contrary to the playing method of the embodiment 1, the payline L is not provided and all the symbols 180 are set as a scatter symbol. In other words, as shown in FIG. 11, the slot machine executes a playing method comprising steps of rearranging the plural scatter symbols 181, based on a predetermined timing, determining a winning through a relationship of the scatter symbols 181 rearranged, controlling the symbols so that a timing for rearranging the symbols in at least one area (one of the display windows 151˜153) is different from a timing for rearranging the symbols in another area; and under state before the scatter symbols 181 are rearranged in the one area, when a symbol 181 to be rearranged in the one area is at a stage having a possibility that a winning will occur in connection with the symbols 181 having been already rearranged in the areas, outputting the voice related to the winning from the speaker 29.

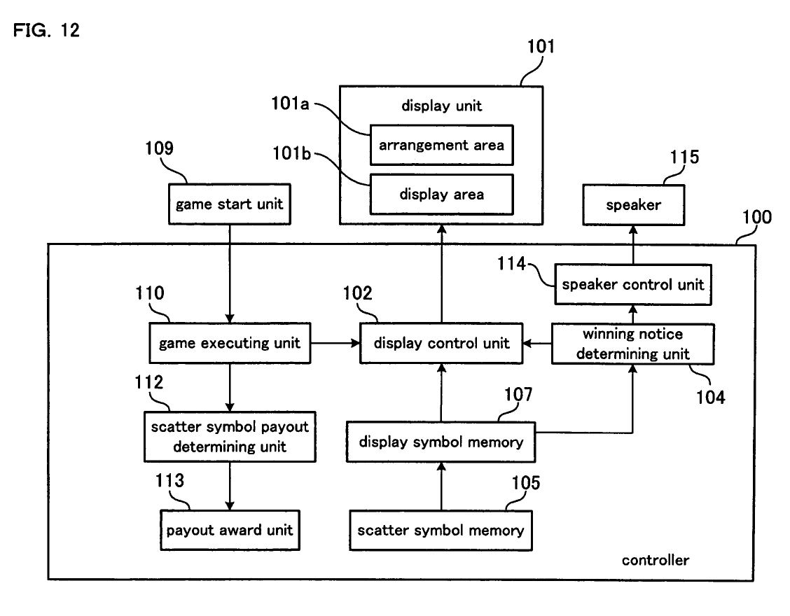

The slot machine 10 of the invention has a display unit (display) 101, a speaker 115 and a controller 100, as shown in FIG. 12. The display unit 101 is structured to arrange plural scatter symbols 181.

The controller 100 is structured to execute a first process of arranging the scatter symbols 181 in an arrangement area 101a (display windows 151˜153) of the display (display unit 101) and rearranging the scatter symbols 181 based on timings each of which is set to be different in the respective display windows 151˜153, a second process of awarding a payout determined by the scatter symbols 181 rearranged, a third process of under state before the scatter symbols 181 are rearranged in the any one arrangement area 101a, determining whether a scatter symbol 181 to be rearranged in the any one arrangement area 101a has a possibility that a winning will occur in connection with the scatter symbols 181 having been already arranged in the arrangement area 101a, and a fourth process of outputting the voice related to a winning having an occurrence possibility from the speaker 115. In other words, the controller 100 comprises first to fourth processing units. Specifically, the slot machine of the embodiment 2 is not provided with the symbol memory and the combination payout determining unit of the embodiment 1, and the other structures and operations are same as in the embodiment 1.

Thereby, the slot machine 10 embodies the playing method of under state before the scatter symbols 181 are rearranged in the part of arrangement area 101a (one of the display windows 151˜153), when a scatter symbol 181 to be rearranged in the arrangement area 101a has a possibility that a winning will occur in connection with the scatter symbols 181 having been already arranged in the arrangement area 101a, outputting the voice related to a winning (a winning having an occurrence possibility) depending on the scatter symbol 181 (final symbol 182) from the speaker 115. As a result, the voice related to a winning having an occurrence possibility is outputted from the speaker 115, so that the player can intuitively recognize which winning has a possibility that it will be made, although it is difficult to know whether a winning enabling a payout to be awarded is made since all the symbols are a scatter symbol and the payline is not provided.

Although the above descriptions have been provided with regard to the characteristic parts so as to understand the invention more easily, the invention is not limited to the embodiments as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps and blocks. Although the processes in the respective steps and blocks embody the signal as a bit, value, symbol, character, term, number and the like, it should be noted that these have been used for the convenience of descriptions. Further, although the processes in the respective steps and blocks have been often described as an expression common to a human action, the process described in the specification is executed by a variety of devices in principle. In addition, the other structures necessary for the respective steps and blocks are apparent from the above descriptions.

What is claimed is:

1. A slot machine comprising:
a display forming a plurality of areas for arranging plural symbols,
a speaker for outputting voice, and
a controller programmed:
(a) to rearrange the plural symbols in the areas, based on a predetermined timing,
(b) to determine a winning through a relation of the symbols rearranged, and
(c) to control the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, to output voice related to the winning from the speaker.

2. A slot machine comprising:
a display having a plurality of paylines and forming a plurality of areas for arranging plural symbols so that the areas intersect the paylines,
a speaker for outputting voice, and
a controller programmed:
(a) to rearrange the plural symbols on the paylines, based on a predetermined timing,
(b) to determine a winning through a relation of the symbols rearranged on the paylines, and
(c) to control the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, to output voice related to the winning from the speaker.

3. A slot machine comprising:
a display forming a plurality of areas for arranging plural symbols including plural scatter symbols,
a speaker for outputting voice, and
a controller programmed:
(a) to rearrange the plural symbols, based on a predetermined timing,
(b) to determine a winning through a relation of scatter symbols rearranged which are the rearranged symbols, and
(c) to control the symbols so that a timing for rearranging the symbols in at least one area is different from a timing for rearranging the symbols in another area, and, under state before the symbols are rearranged in the one area, when a scatter symbol to be rearranged in the one area is at a stage having a possibility that a winning will occur in connection with the scatter symbols having been already rearranged in the areas, to output voice related to the winning from the speaker.

4. A slot machine comprising:
a display having a plurality of paylines and forming a plurality of areas for arranging plural symbols including plural scatter symbols so that the areas intersect the paylines,
a speaker for outputting voice, and
a controller programmed:
(a) to rearrange the plural symbols on the paylines, based on a predetermined timing,
(b) to determine a winning through a relation of the symbols rearranged on the paylines or a relation of scatter symbols rearranged which are the rearranged symbols, and
(c) to control the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, to output voice related to the winning from the speaker.

5. A playing method of a slot machine using a display forming a plurality of areas for arranging plural symbols, the method comprising steps of:
(a) rearranging the plural symbols, based on a predetermined timing;
(b) determining a winning through a relation of the symbols rearranged; and
(c) controlling the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, outputting voice related to the winning from a speaker.

6. A playing method of a slot machine using a display having a plurality of paylines and forming a plurality of areas for arranging plural symbols so that the areas intersect the paylines, the method comprising steps of:
(a) rearranging the plural symbols on the paylines, based on a predetermined timing;
(b) determining a winning through a relation of the symbols rearranged on the paylines; and
(c) controlling the symbols so that a timing for rearranging the symbols in at least one area is different from a timing for rearranging the symbols in another area; and, under state before the symbols are rearranged in the one area, when a symbol to be rearranged in the one area is at a stage having a possibility that a winning will occur in connection with the symbols having been already rearranged in the areas, outputting voice related to the winning from a speaker.

7. A playing method of a slot machine using a display forming a plurality of areas for arranging plural symbols including plural scatter symbols, the method comprising steps of:
(a) rearranging the plural symbols, based on a predetermined timing;
(b) determining a winning through a relation of scatter symbols rearranged which are the rearranged symbols; and
(c) controlling the symbols so that a timing for rearranging the symbols in at least one area is different from a timing for rearranging the symbols in another area, and, under state before the symbols are rearranged in the one area, when a scatter symbol to be rearranged in the one area is at a stage having a possibility that a winning will occur in connection with the scatter symbols having been already rearranged in the areas, outputting voice related to the winning from a speaker.

8. A playing method of a slot machine using a display having a plurality of paylines and forming a plurality of areas for arranging plural symbols including plural scatter symbols so that the areas intersect the paylines, the method comprising steps of:
(a) rearranging the plural symbols on the paylines, based on a predetermined timing;
(b) determining a winning through a relation of the symbols rearranged on the paylines or a relation of scatter symbols rearranged which are the rearranged symbols; and
(c) controlling the symbols so that a timing for rearranging the symbols in at least one area is different from a timing for rearranging the symbols in another area, and, under state before the symbols are rearranged in the one area, when a symbol to be rearranged in the one area is at a stage having a possibility that a winning will occur in connection with the symbols having been already rearranged in the areas, outputting voice related to the winning from a speaker.
